(19) United States
(12) Patent Application Publication
(10) Pub. No.: US 2024/0193616 A1
(43) Pub. Date: Jun. 13, 2024

(54) AUTOMATED CORRECTION OF ERRONEOUS ENTRY OF ALPHANUMERIC ITEM IDENTIFIERS USING DISTANCE EVALUATION

(71) Applicant: Dell Products L.P., Round Rock, TX (US)

(72) Inventors: Walter Cristian Bruck Mundstock, Porto Alegre (BR); Daniel Carvalho Liedke, Porto Alegre (BR); João Francisco Homrich da Jornada, Porto Alegre (BR); Gustavo Machado Rodrigues, Porto Alegre (BR)

(21) Appl. No.: 18/078,656

(22) Filed: Dec. 9, 2022

(51) Int. Cl. G06Q 30/015

(52) U.S. Cl. CPC G06Q 30/015

(57) ABSTRACT

Techniques are provided for automated correction of erroneous entry of alphanumeric item identifiers using distance evaluation. One method comprises obtaining a message sent by a user, wherein the message comprises an erroneous first alphanumeric identifier of a given item associated with the user; obtaining an identifier of the user; identifying one or more second alphanumeric identifiers of one or more items previously associated with the identifier of the user; evaluating a distance of the first alphanumeric identifier from the one or more second alphanumeric identifiers; selecting a given one of the second alphanumeric identifiers based on the distance; and initiate a processing of the message using the selected second alphanumeric identifier. The user may confirm the selected second alphanumeric identifier. The user may be identified using a telephone number, an email address, a social security number or other government-issued identifier, and/or portions or combinations thereof.

### FIELD

The field relates generally to information processing systems and more particularly, to the processing of messages in such information processing systems.

### BACKGROUND

Despite the increased use of automated systems by numerous customer service organizations, the efficiency of such automated systems often depends on data entered by humans, such as customers. Product identification codes, for example, are often long and subject to erroneous entry by the customer.

### SUMMARY

In one embodiment, a method comprises obtaining at least one message sent by a user, wherein the at least one message comprises a first alphanumeric identifier of a given item associated with the user, wherein the first alphanumeric identifier of the given item comprises at least one error; obtaining an identifier of the user; identifying one or more second alphanumeric identifiers of one or more items associated with the identifier of the user, wherein the one or more second alphanumeric identifiers of the one or more items were associated with the identifier of the user prior to the obtaining the at least one message sent by the user; evaluating a distance of the first alphanumeric identifier of the given item from at least some of the one or more second alphanumeric identifiers of the one or more items; selecting a given one of the one or more second alphanumeric identifiers of the one or more items based at least in part on the distance; and initiating a processing of the at least one message using the selected second alphanumeric identifier.

In some embodiments, the user may be requested to confirm the selected second alphanumeric identifier. The obtained identifier of the user may comprise, for example, at least a portion of a telephone number of the user, at least a portion of an email address of the user, at least a portion of an identifier from a government-issued identity card of the user and/or at least a portion of a social security number of the user.

In one or more embodiments, the at least one error comprises one or more of a typing error by the user while entering the alphanumeric identifier of the given item using a keypad and a transcription error of the alphanumeric identifier of the given item spoken by the user. The processing the at least one message may comprise routing one or more of the at least one message based at least in part on the selected second alphanumeric identifier.

In at least one embodiment, the evaluating the distance of the first alphanumeric identifier of the given item from at least some of the one or more second alphanumeric identifiers of the one or more items employs one or more of a Jaro-Winkler distance approximation algorithm and a Levenshtein distance approximation algorithm.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for automated correction of erroneous entry of alphanumeric item identifiers using distance evaluation in accordance with an illustrative embodiment;

FIGS. 2A and 2B, collectively, comprise a flow diagram illustrating an exemplary process for automated correction of erroneous entry of alphanumeric item identifiers using distance evaluation in accordance with an illustrative embodiment;

FIG. 3 is a flow diagram illustrating an exemplary process for automated correction of erroneous entry of alphanumeric item identifiers using distance evaluation in accordance with an illustrative embodiment;

FIG. 4 illustrates an exemplary processing platform that may be used to implement at least a portion of one or more embodiments of the disclosure comprising a cloud infrastructure; and

FIG. 5 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for automated correction of erroneous entry of alphanumeric item identifiers using distance evaluation.

One or more aspects of the disclosure recognize that in a customer service environment, such as a call center, incoming communications, such as telephone calls (or text-based messages) related to a given product of a customer, are often routed to an agent without a correct product identifier (such as a serial number). An Interactive Voice Response system (IVR), for example, often requests a customer to enter information (e.g., using a keypad) to identify a particular product of interest to the customer. When the call is transferred to a support agent, the support agent may be automatically provided with product information for the particular product of interest based on the entered product identity information. In this manner, the total call time may be reduced, thereby increasing customer satisfaction and reducing operational expenses. Product identification codes, however, are often long and subject to erroneous entry by the customer (e.g., a mistyping or an incorrect dictation of a vocal entry by the user), resulting in a substantial number of messages being transferred to an agent with incorrect product identification (resulting, for example, in an increased amount of time to handle a given call, an increased number of transfers between different service queues and/or a lower customer satisfaction).

In one or more embodiments of the disclosure, distance-based item identifier correction techniques are provided that automatically correct an item identification code entered by a user and thereby reduce the percentage of communications that are transferred to an agent without a proper item identifier. In some embodiments, the customer is identified, for example, using a caller identification or another user identifier, and an approximate string-matching technique (sometimes referred to as fuzzy string searching) to find a best match for existing item identifiers (e.g., product codes) belonging to a given customer. The disclosed distance-based item identifier correction techniques compare an item identifier provided by a user as part of a communication to item identifiers that have previously been associated with the same user.

Among other benefits, the disclosed techniques for automated correction of erroneous entry of alphanumeric item identifiers using distance evaluation significantly reduce a number of communications that do not have a correct item (e.g., product) identifier. In addition, by limiting the approximate string matching to item identifiers that have previously been associated with the same user (e.g., using an identifier of the user), the search space is significantly reduced (thereby reducing the computational complexity of the disclosed approach).

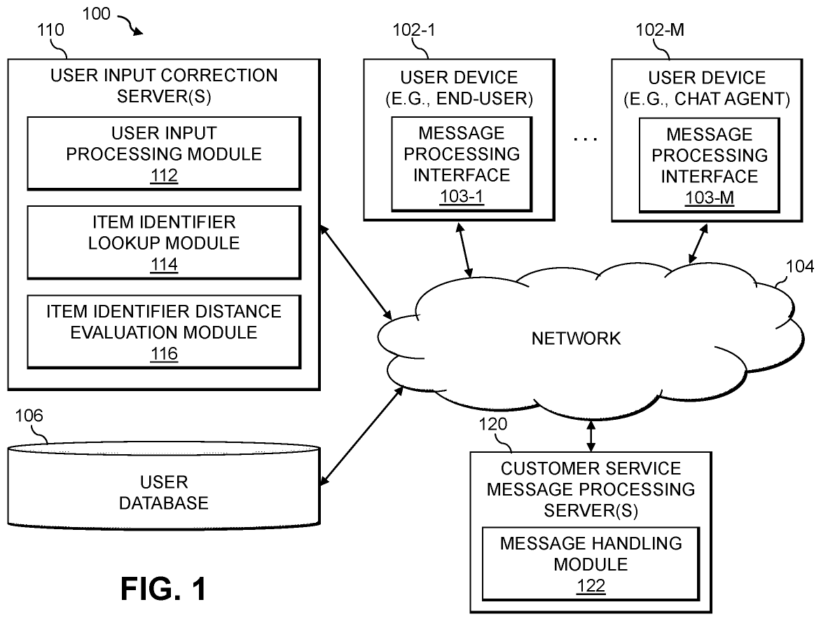

FIG. 1 shows a computer network (also referred to herein as an information processing system) 100 configured in accordance with an illustrative embodiment. The computer network 100 comprises a plurality of user devices 102-1 through 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 are a user database 106, one or more user input correction servers 110 and one or more customer service message processing servers 120.

The user devices 102 may be employed by end-users (e.g., customers) and/or customer service or other chat agents for telephone and/or messaging-based communications (e.g., chat services), as discussed further below, and may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

The user devices 102 in the example of FIG. 1 comprise corresponding message processing interfaces 103-1 through 103-M (collectively, referred to herein as message processing interfaces 103), discussed further below.

Also, it is to be appreciated that the term “user” in this context and elsewhere herein is intended to be broadly construed so as to encompass, for example, human, hardware, software or firmware entities, as well as various combinations of such entities.

Also associated with the user devices 102 are one or more input-output devices, which illustratively comprise keyboards, displays or other types of input-output devices in any combination. Such input-output devices can be used, for example, to support one or more user interfaces to the user devices 102, as well as to support communication between the customer service message processing servers 120 and/or other related systems and devices not explicitly shown.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The user input correction servers 110 and the customer service message processing servers 120 in the FIG. 1 embodiment are assumed to be implemented using at least one processing device. Each such processing device generally comprises at least one processor and an associated memory, and implements one or more functional modules for controlling certain features of the user input correction servers 110 and/or the customer service message processing servers 120.

More particularly, the user input correction servers 110 and the customer service message processing servers 120 in this embodiment can each comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interfaces allow for communication between the user input correction servers 110, the customer service message processing servers 120 and/or the user devices 102 over the network 104, and each illustratively comprises one or more conventional transceivers.

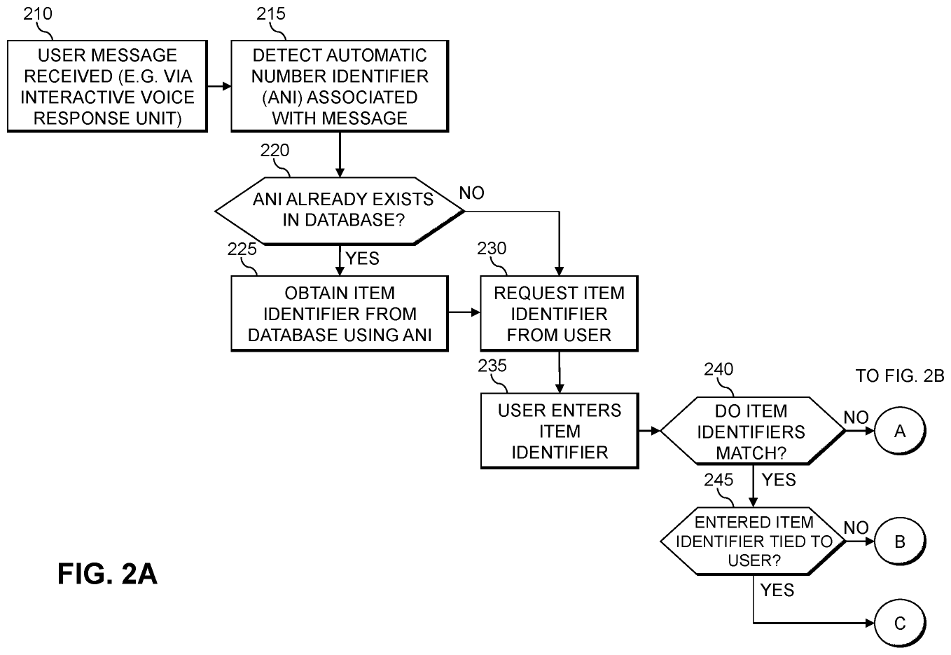

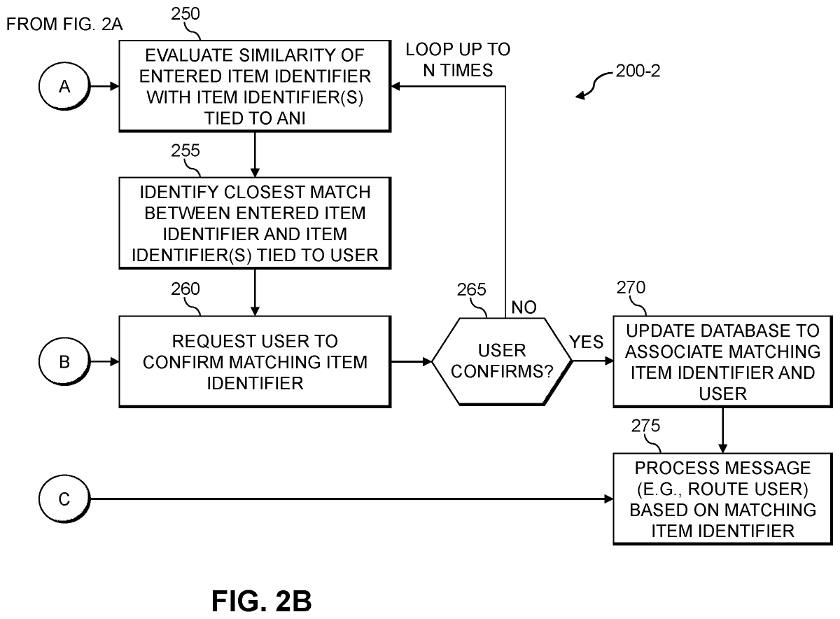

In the example of FIG. 1, the user input correction server 110 may comprise a user input processing module 112, an item identifier lookup module 114 and an item identifier distance evaluation module 116. Generally, the user input processing module 112 may be configured to process data (e.g., a product identifier) entered by a user, for example, using a keypad or spoken by the user. The item identifier lookup module 114 employs the disclosed distance-based item identifier correction techniques, as discussed further below in conjunction with FIGS. 2A and 2B, for example, to determine whether an item identifier entered by a user is associated with the user, or to identify items that have been previously associated with the user. The item identifier distance evaluation module 116 evaluates the distance between an item identifier entered by the user and item identifiers previously associated with the user.

In the example of FIG. 1, the representative customer service message processing server 120 supports telephone and/or messaging-based communications (e.g., telephone and/or chat services related to, for example, customer support, customer product queries and other customer transactions). The customer service message processing server 120 may be implemented, for example, at least in part, using an IVR system and/or the messaging platform provided by Salesforce.com, Inc., as modified herein to provide the disclosed features and functions for distance-based item identifier correction. The customer service message processing servers 120 may comprise a message handling module 122 that comprises server-side functionality, for example, using an application programming interface, that interacts with the message processing interfaces 103 of the user devices 102 and the user input correction server 110, such as intercepting messages between end-users and customer service agents before such intercepted messages are displayed to the respective end-users and customer service agents and to provide such intercepted messages to the user input correction server 110 to implement the disclosed distance-based item identifier correction functionality. In addition, the message handling module 122 comprises functionality to present the predicted item identifier corrections to users, optionally with corresponding confidence scores, for the user to select and/or confirm item identifier corrections that may be used, for example, to route messages to the appropriate chat agent or support queue.

It is to be appreciated that the particular arrangement of elements 112, 114, 116 illustrated in the representative user input correction server 110 and the element 122 illustrated in the representative customer service message processing server 120 of the FIG. 1 embodiment is presented by way of example only, and alternative arrangements can be used in other embodiments. For example, the functionality associated with the elements 112, 114, 116 and element 122 in other embodiments can be combined into a single element, or separated across a larger number of elements. As another example, multiple distinct processors can be used to implement different ones of the elements 112, 114, 116 and/or element 122, or portions thereof.

At least portions of elements 112, 114, 116 and/or element 122 may be implemented at least in part in the form of software that is stored in memory and executed by a processor.

The user input correction servers 110 and/or the customer service message processing servers 120 can have at least one associated user database 106, configured to store data pertaining to, for example, customer information, message interaction histories, product identifiers and order histories.

The user database 106 can be implemented using one or more corresponding storage systems. Such storage systems can comprise any of a variety of different types of storage including network-attached storage (NAS), storage area networks (SANs), direct-attached storage (DAS) and distributed DAS, as well as combinations of these and other storage types, including software-defined storage.

It is to be understood that the particular set of elements shown in FIG. 1 for automated correction of erroneous entry of alphanumeric item identifiers using distance evaluation is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the customer service message processing servers 120 and at least one associated database can be on and/or part of the same processing platform.

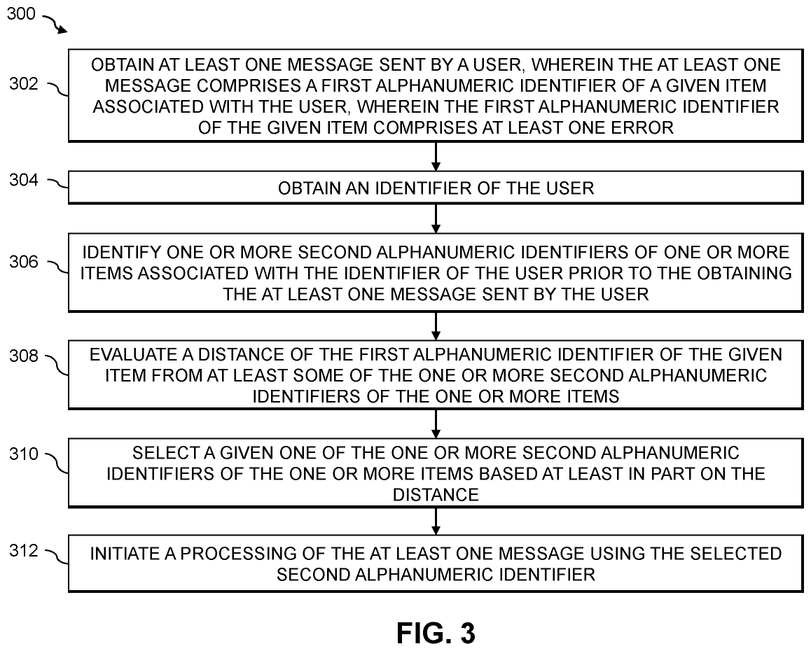

An exemplary process utilizing elements 112, 114, 116 of the user input correction server 110 and element 122 of the customer service message processing server 120 in computer network 100 will be described in more detail with reference to, for example, FIGS. 2A, 2B and 3.

FIGS. 2A and 2B, collectively, comprise a flow diagram illustrating an exemplary process for automated correction of erroneous entry of alphanumeric item identifiers using distance evaluation in accordance with an illustrative embodiment. In the example of FIG. 2A, a user message is received in step 210. For example, a customer may call a telephone number managed by an IVR unit (e.g., to obtain technical support for a particular product).

In step 215, an automatic number identifier (ANI), for example, associated with message is detected (or another user identifier). In the case of a telephone call, an IVR may automatically identify the originating customer telephone number. IVR systems typically allow humans to interact with a computer-operated telephone system using, for example, voice and DTMF (dual tone multi-frequency) tones entered using a telephone keypad. ANI is a telephony service that allows the receiver of a telephone call to capture the telephone number of the telephone that originated the call (sometimes referred to as caller identification).

In other examples, the user may be identified in step 215, for example, using a telephone number, an email address, an identifier from a government-issued identity card (e.g., a driver's license), a social security number, and/or portions or combinations of these or other types of user-identifying information.

A test is performed in step 220 to determine if the ANI already exists in the database (e.g., user database 106) associated with the IVR, for example. If it is determined in step 220 that the ANI does not exist in the database, then program control proceeds to step 230, discussed below.

If, however, it is determined in step 220 that the ANI already exists in the database, then one or more item identifiers are obtained from the database using the ANI in step 225. For example, identifiers of products previously associated with the ANI may be retrieved.

If it is determined in step 220 that the ANI does not exist in the database, or following performance of step 225, an item identifier is requested from the user in step 230. For example, the IVR may request an item identifier related to the product that is the subject of the call.

In step 235, the user enters the requested item identifier, for example, using the telephone keypad.

A test is performed in step 240 to determine if the item identifier entered by the user in step 235 matches an item identifier obtained from the database in step 225 using the ANI of the customer.

If it is determined in step 240 that the item identifiers do not match, then program control proceeds to step 250 (FIG. 2B), discussed below. If, however, it is determined in step 240 that the item identifiers match, then a further test is performed in step 245 to determine if the item identifier entered by the user in step 235 was previously associated with the user (for example, using the ANI or another user identifier). If it is determined in step 245 that the item identifier entered by the user in step 235 was not previously associated with the user, then program control proceeds to step 260 (FIG. 2B), discussed below.

If, however, it is determined in step 245 that the item identifier entered by the user in step 235 was previously associated with the user, then program control proceeds to step 275 (FIG. 2B), discussed below, as there was an exact match between the item identifier entered by the user in step 235 and an item identifier previously associated with the user and the message can be automatically routed accordingly to the correct support queue.

In step 250, the similarity of the item identifier entered by the user in step 235 is evaluated with any item identifiers previously associated with the user (for example, using the ANI or another user identifier). The similarity of the item identifier entered by the user and any item identifiers previously associated with the user may be evaluated, for example, using a Jaro-Winkler distance approximation algorithm and/or a Levenshtein distance approximation algorithm. For example, if a correct item identifier of the user is “7817428374” and the user entered an item identifier of “8175281374,” the Levenshtein distance between the two identifiers is 3.

In some embodiments, in the event of two item identifiers previously associated with the user having the same similarity to the item identifier entered by the user in step 235, a tie breaker may be performed, for example, using timestamps of when the two item identifiers were previously associated with the user to prioritize the most recently added item, for example.

In step 255, a closest match (or a top N list) between the similarity of the item identifier entered by the user in step 235 and any item identifiers associated with the user is identified. The user is requested to confirm the matching item identifier in step 260. A test is performed in step 265 to determine if the user confirms the matching item identifier. If it is determined in step 265 that the user does not confirm the matching item identifier, then program control may return to step 250 (for example, up to N times) to evaluate another item identifier in a top N list.

If it is determined in step 265 that the user confirms the matching item identifier, then the database is updated in step 270 to associate the matching item identifier with the user (for example, using the ANI or another user identifier).

In step 275, the message is processed based on the matching item identifier (e.g., route the user to a call agent or support queue associated with the product identified by the matching item identifier).

FIG. 3 is a flow diagram illustrating an exemplary process 300 for automated correction of erroneous entry of alphanumeric item identifiers using distance evaluation in accordance with an illustrative embodiment. In the example of FIG. 3, the process 300 initially obtains at least one user message sent by a user in step 302. The at least one message comprises a first alphanumeric identifier of a given item associated with the user, and the first alphanumeric identifier of the given item comprises at least one error.

In step 304, an identifier of the user is obtained (for example, in response to, or in connection with, the obtaining the at least one message of step 302). One or more second alphanumeric identifiers are identified in step 306 of one or more items associated with the identifier of the user prior to the obtaining the at least one message sent by the user.

A distance of the first alphanumeric identifier of the given item from at least some of the one or more second alphanumeric identifiers of the one or more items is evaluated in step 308, and a given one of the one or more second alphanumeric identifiers of the one or more items is selected in step 310 based at least in part on the distance. The processing of the at least one message using the selected second alphanumeric identifier is initiated in step 312.

In some embodiments, the at least one message comprising the alphanumeric identifier of the given item is obtained from the user as part of a customer service interaction with the user related to the given item. The at least one message may be part of a telephonic communication with the user and/or a text-based communication with the user.

In one or more embodiments, the user is requested to confirm the selected second alphanumeric identifier. The identifier of the user may comprise one or more of at least a portion of a telephone number of the user, at least a portion of an email address of the user, at least a portion of an identifier from a government-issued identity card (such as a driver's license) of the user and at least a portion of a social security number of the user.

In at least one embodiment, the given item associated with the user comprises one or more of a product of the user, a service of the user and an account of the user. The at least one error may comprise a typing error by the user while entering the alphanumeric identifier of the given item using a keypad and/or a transcription error of the alphanumeric identifier of the given item spoken by the user. The processing the at least one message may comprise routing one or more of the at least one message based at least in part on the selected second alphanumeric identifier. The evaluating the distance of the first alphanumeric identifier of the given item from at least some of the one or more second alphanumeric identifiers of the one or more items employs a Jaro-Winkler distance approximation algorithm and/or a Levenshtein distance approximation algorithm.

The particular processing operations and other network functionality described in conjunction with the flow diagrams of FIGS. 2A, 2B and 3 are presented by way of illustrative example only, and should not be construed as limiting the scope of the disclosure in any way.

Alternative embodiments can use other types of processing operations for automated correction of erroneous entry of alphanumeric item identifiers using distance evaluation. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

In some embodiments, the disclosed techniques for automated correction of erroneous entry of alphanumeric item identifiers using distance evaluation provide a solution that may be One or more embodiments of the disclosure provide improved methods, apparatus and computer program products for automated correction of erroneous entry of alphanumeric item identifiers using distance evaluation. The disclosed distance-based item identifier correction techniques significantly reduce a number of communications that do not have a correct item identifier. In addition, by limiting the approximate string matching to item identifiers that have previously been associated with the same user (e.g., using a user identifier), the search space is significantly reduced (thereby reducing the computational complexity of the disclosed similarity evaluation approach).

The foregoing applications and associated embodiments should be considered as illustrative only, and numerous other embodiments can be configured using the techniques disclosed herein, in a wide variety of different applications.

It should also be understood that the disclosed techniques for distance-based item identifier correction, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for automated correction of erroneous entry of alphanumeric item identifiers using distance evaluation may be implemented using one or more processing platforms.

One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform as a service (PaaS) model, an Infrastructure as a service (IaaS) model, a Storage-as-a-Service (STaaS) model and/or a Function-as-a-Service (FaaS) model, although numerous alternative arrangements are possible. Also, illustrative embodiments can be implemented outside of the cloud infrastructure context, as in the case of a stand-alone computing and storage system implemented within a given enterprise.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based distance-based item identifier correction engine, or portions thereof, are illustratively implemented for use by tenants of such a multi-tenant environment.

Cloud infrastructure as disclosed herein can include cloud-based systems such as AWS, GCP and Microsoft Azure. Virtual machines provided in such systems can be used to implement at least portions of a cloud-based distance-based item identifier correction platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

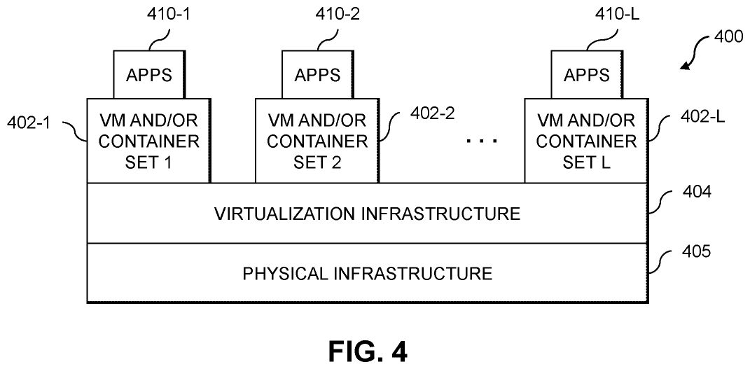

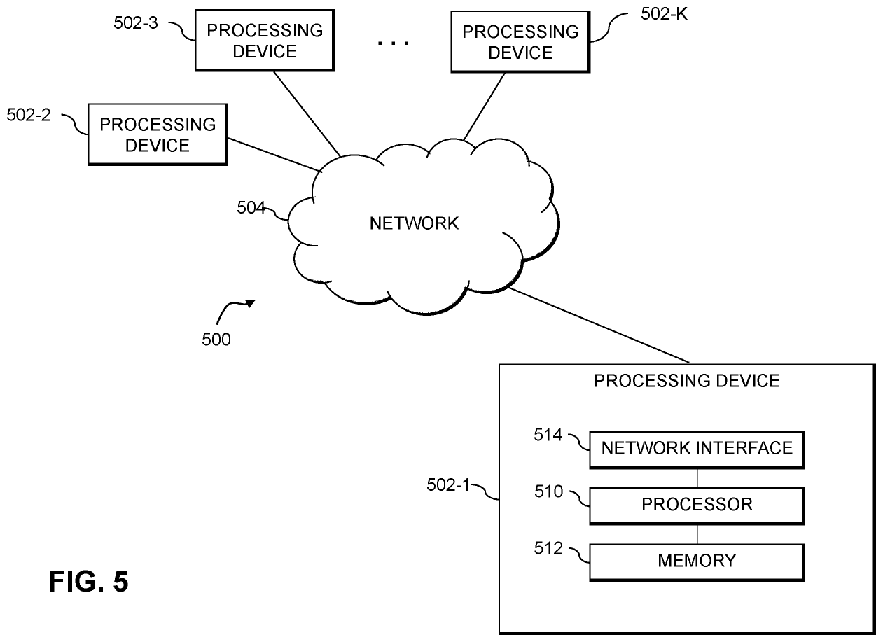

Illustrative embodiments of processing platforms will now be described in greater detail with reference to FIGS. 4 and 5. These platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. Such implementations can provide distance-based item identifier correction functionality of the type described above for one or more processes running on a given one of the VMs. For example, each of the VMs can implement distance-based item identifier correction control logic and associated functionality for processing messages using corrected item identifiers.

An example of a hypervisor platform that may be used to implement a hypervisor within the virtualization infrastructure 404 is the VMware® vSphere® which may have an associated virtual infrastructure management system such as the VMware® vCenter™. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system. Such implementations can provide distance-based item identifier correction functionality of the type described above for one or more processes running on different ones of the containers. For example, a container host device supporting multiple containers of one or more container sets can implement one or more instances of distance-based item identifier correction control logic and associated functionality for processing messages using corrected item identifiers.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises at least a portion of the given system and includes a plurality of processing devices, denoted 502-1, 502-2, 502-3, . . . 502-K, which communicate with one another over a network 504. The network 504 may comprise any type of network, such as a WAN, a LAN, a satellite network, a telephone or cable network, a cellular network, a wireless network such as WiFi or WiMAX, or various portions or combinations of these and other types of networks.

The processing device 502-1 in the processing platform 500 comprises a processor 510 coupled to a memory 512. The processor 510 may comprise a microprocessor, a microcontroller, an ASIC, an FPGA or other type of processing circuitry, as well as portions or combinations of such circuitry elements, and the memory 512, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals.

Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 4 or 5, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining at least one message sent by a user, wherein the at least one message comprises a first alphanumeric identifier of a given item associated with the user, wherein the first alphanumeric identifier of the given item comprises at least one error;
obtaining an identifier of the user;
identifying one or more second alphanumeric identifiers of one or more items associated with the identifier of the user, wherein the one or more second alphanumeric identifiers of the one or more items were associated with the identifier of the user prior to the obtaining the at least one message sent by the user;
evaluating a distance of the first alphanumeric identifier of the given item from at least some of the one or more second alphanumeric identifiers of the one or more items;
selecting a given one of the one or more second alphanumeric identifiers of the one or more items based at least in part on the distance; and
initiating a processing of the at least one message using the selected second alphanumeric identifier;
wherein the method is performed by at least one processing device comprising a processor coupled to a memory.

2. The method of claim 1, wherein the at least one message comprising the first alphanumeric identifier of the given item is obtained from the user as part of a customer service interaction with the user related to the given item.

3. The method of claim 1, wherein the at least one message is part of one or more a telephonic communication with the user and a text-based communication with the user.

4. The method of claim 1, further comprising requesting confirmation from the user of the selected second alphanumeric identifier.

5. The method of claim 1, wherein the obtained identifier of the user comprises one or more of at least a portion of a telephone number of the user, at least a portion of an email address of the user, at least a portion of an identifier from a government-issued identity card of the user and at least a portion of a social security number of the user.

6. The method of claim 1, wherein the given item associated with the user comprises one or more of a product of the user, a service of the user and an account of the user.

7. The method of claim 1, wherein the at least one error comprises one or more of a typing error by the user while entering the first alphanumeric identifier of the given item using a keypad and a transcription error of the first alphanumeric identifier of the given item spoken by the user.

8. The method of claim 1, wherein the processing the at least one message comprises routing one or more of the at least one message based at least in part on the selected second alphanumeric identifier.

9. The method of claim 1, wherein the evaluating the distance of the first alphanumeric identifier of the given item from at least some of the one or more second alphanumeric identifiers of the one or more items employs one or more of a Jaro-Winkler distance approximation algorithm and a Levenshtein distance approximation algorithm.

10. An apparatus comprising:
at least one processing device comprising a processor coupled to a memory;
the at least one processing device being configured to implement the following steps:
obtaining at least one message sent by a user, wherein the at least one message comprises a first alphanumeric identifier of a given item associated with the user, wherein the first alphanumeric identifier of the given item comprises at least one error;
obtaining an identifier of the user;
identifying one or more second alphanumeric identifiers of one or more items associated with the identifier of the user, wherein the one or more second alphanumeric identifiers of the one or more items were associated with the identifier of the user prior to the obtaining the at least one message sent by the user;
evaluating a distance of the first alphanumeric identifier of the given item from at least some of the one or more second alphanumeric identifiers of the one or more items;
selecting a given one of the one or more second alphanumeric identifiers of the one or more items based at least in part on the distance; and
initiating a processing of the at least one message using the selected second alphanumeric identifier.

11. The apparatus of claim 10, further comprising requesting confirmation from the user of the selected second alphanumeric identifier.

12. The apparatus of claim 10, wherein the obtained identifier of the user comprises one or more of at least a portion of a telephone number of the user, at least a portion of an email address of the user, at least a portion of an identifier from a government-issued identity card of the user and at least a portion of a social security number of the user.

13. The apparatus of claim 10, wherein the at least one error comprises one or more of a typing error by the user while entering the first alphanumeric identifier of the given item using a keypad and a transcription error of the first alphanumeric identifier of the given item spoken by the user.

14. The apparatus of claim 10, wherein the processing the at least one message comprises routing one or more of the at least one message based at least in part on the selected second alphanumeric identifier.

15. The apparatus of claim 10, wherein the evaluating the distance of the first alphanumeric identifier of the given item from at least some of the one or more second alphanumeric identifiers of the one or more items employs one or more of a Jaro-Winkler distance approximation algorithm and a Levenshtein distance approximation algorithm.

16. A non-transitory processor-readable storage medium having stored therein program code of one or more software programs, wherein the program code when executed by at least one processing device causes the at least one processing device to perform the following steps:
obtaining at least one message sent by a user, wherein the at least one message comprises a first alphanumeric identifier of a given item associated with the user, wherein the first alphanumeric identifier of the given item comprises at least one error;
obtaining an identifier of the user;
identifying one or more second alphanumeric identifiers of one or more items associated with the identifier of the user, wherein the one or more second alphanumeric identifiers of the one or more items were associated with the identifier of the user prior to the obtaining the at least one message sent by the user;
evaluating a distance of the first alphanumeric identifier of the given item from at least some of the one or more second alphanumeric identifiers of the one or more items;
selecting a given one of the one or more second alphanumeric identifiers of the one or more items based at least in part on the distance; and
initiating a processing of the at least one message using the selected second alphanumeric identifier.

17. The non-transitory processor-readable storage medium of claim 16, further comprising requesting confirmation from the user of the selected second alphanumeric identifier.

18. The non-transitory processor-readable storage medium of claim 16, wherein the obtained identifier of the user comprises one or more of at least a portion of a telephone number of the user, at least a portion of an email address of the user, at least a portion of an identifier from a government-issued identity card of the user and at least a portion of a social security number of the user.

19. The non-transitory processor-readable storage medium of claim 16, wherein the processing the at least one message comprises routing one or more of the at least one message based at least in part on the selected second alphanumeric identifier.

20. The non-transitory processor-readable storage medium of claim 16, wherein the evaluating the distance of the first alphanumeric identifier of the given item from at least some of the one or more second alphanumeric identifiers of the one or more items employs one or more of a Jaro-Winkler distance approximation algorithm and a Levenshtein distance approximation algorithm.
